(19) United States
(12) Patent Application Publication
(10) Pub. No.: US 2025/0055343 A1
(43) Pub. Date: Feb. 13, 2025

(54) STATOR

(71) Applicant: DENSO CORPORATION, Kariya-city (JP)

(72) Inventor: Seiichi MURAKAMI, Kariya-city (JP)

(73) Assignee: DENSO CORPORATION, Kariya-city (JP)

(21) Appl. No.: 18/931,991

(22) Filed: Oct. 30, 2024

Related U.S. Application Data
(63) Continuation of application No. PCT/JP2023/018400, filed on May 17, 2023.

(30) Foreign Application Priority Data
May 18, 2022 (JP) 2022-081789

(51) Int. Cl. H02K 3/52

(52) U.S. Cl. CPC H02K 3/522; H02K 2203/12

(57) ABSTRACT

A stator includes a plurality of insulators and a plurality of coils. Each of the insulators has a plurality of retention grooves and a plurality of stopper protrusions. Each of the stopper protrusions has a contact surface which makes physical contact with an end of a third or subsequent odd-numbered layers of turns of a corresponding one of the coils. Each of the contact surfaces has a first end and a second end which opposed to each other in a direction perpendicular to a first direction and a reference axis. The first end is located closer to a corresponding one of the teeth than the second end is. The contact surface is inclined to have the second end located farther away from a corresponding one of the coils than the first end is in the first direction.

### CROSS REFERENCE TO RELATED DOCUMENT

The present application claims the benefit of priority of Japanese Patent Application No. 2022-081789 filed on May 18, 2022, the disclosure of which is incorporated in its entirety herein by reference.

### Technical Field

This disclosure relates generally to a stator.

### BACKGROUND ART

A stator installed in some typical electrical motors includes a store core with teeth and coils wound around the teeth. For instance, each of the coils is made by a conductive wire wound around a respective one of the teeth in the form of multiple layers through an insulator attached to the stator core. The insulator is specifically designed according to the diameter of the conductive wire to hold turns of the conductive wire which form a first one of the layers of each coil (which will also be referred to below as first layer turns) so that the first layer turns are arranged at constant intervals away from each other in a direction from a top end (facing inward of the coil) to a base end (facing outward of the coil) of a corresponding one of the teeth. Japanese Patent No. 6065436 listed below teaches an insulator which has formed therein guide grooves which hold first layer turns of a conductive wire of each coil. The guide grooves extend parallel to each other and are arranged at an interval away from each other which is substantially equal to a diameter of the conductive wire. Each of the guide grooves has an arc-shaped inner surface contoured to conform with an outer periphery of the conductive wire.

### PRIOR ART DOCUMENT

### Patent Literature

FIRST PATENT LITERATURE: Japanese Patent No. 6065436

### SUMMARY OF THE INVENTION

The stator disclosed in the above publication, as described above, has the first layer turns of each coil fit in the guide grooves to ensure the stability in locations of the first layer turns in a direction from the top end to the base end of the tooth. The second or subsequent layer turns of the conductive wire are also retained in positions thereof by the previous layer turns, so that they are fixed in the direction from the top end to the base end of the tooth. This minimizes a risk of undesirable deformation of the coils.

The specific design of the insulator for the diameter of the conductive wire of each coil, however, requires the need for re-designing the insulator according to a change in diameter of the conductive wire regardless of the configuration of the stator core, thereby resulting in an increased variation in type of the insulator. This may lead to an increase in cost for producing, for example, molds to form required types of insulators or managing the types of the insulators.

It is an object of this disclosure to provide a stator designed to minimize deformation of a coil which arises from a change in diameter of wire of the coil and also to decrease a required variation in type of an insulator.

According to one aspect of this disclosure, there is provided a stator which comprises: (a) a stator core which includes an annular member and teeth, the annular member having a first surface extending in a reference axis, the annular member being centered at the reference axis, the teeth extending from the first surface in a direction perpendicular to the reference axis, each of the teeth having a top end defining a radially inner end and a base end defining a radially outer end; (b) a plurality of insulators each of which is fit on a respective one of the teeth; and (c) a plurality of coils each of which is made of a conductive wire wound around a respective one of the teeth through a respective one of the insulators in a form of three or more layers of turns. Each of the insulators includes first adjacent walls, second adjacent walls, a plurality of retention grooves, and a plurality of stopper protrusions. The first adjacent walls are arranged away from a corresponding one of the coils in a first direction oriented from the top end to the base end of a corresponding one of the teeth. The first adjacent walls cover at least a portion of the first surface and are located adjacent to a corresponding one of the coils in the first direction. The second adjacent walls are arranged away from a corresponding one of the coils in a second direction oriented from the base end to the top end of a corresponding one of the teeth and located adjacent to a corresponding one of the coils in the second direction. Each of the retention grooves extend in a winding direction in which a corresponding one of the coils is wound around a corresponding one of the teeth. The retention grooves have disposed therein first layer turns that are the turns of the conductive wire making a first one of the layers. The stopper protrusions protrude from at least one of the first adjacent walls and the second adjacent walls toward a corresponding one of the coils. The retention grooves are arranged at equal intervals away from each other. Each of the retention grooves has a pair of holding surfaces which face each other in the first direction. The holding surfaces are oriented to slant in the first direction to have an interval therebetween in the first direction which increases from a bottom toward an opening of a corresponding one of the retention grooves. The holding surfaces of each of the retention grooves are placed in contact with an outer peripheral surface of a corresponding one of the turns which is disposed in a corresponding one of the retention grooves. Each of the stopper protrusions has a contact surface which contacts an end of a third or subsequent odd-numbered layer of the turns of a corresponding one of the coils in the first direction. The contact surface of each of the stopper protrusions has a first end and a second end which opposed to each other in a direction perpendicular to the first direction, as viewed along the reference axis. The first end is located closer to a corresponding one of the teeth than the second end is. The contact surface is inclined to have the second end located farther away from a corresponding one of the coils than the first end is in the first direction.

The holding surfaces of each of the retention grooves are, as described above, oriented to slant relative to each other in the first direction to have an interval therebetween in the first direction which increases from the bottom toward the opening thereof. This achieves the stability in positioning the first layer turns of the conductive wire of each of the coils in the first direction within the retention grooves as long as the conductive wire is placed in contact with both the holding surfaces regardless of the diameter of the conductive wire.

The first layer turns of the conductive wire of each of the coils are fit in the retention grooves arranged at equal intervals away from each other in the first direction, so that they are wound at constant intervals away from each other around a corresponding one of the teeth. The second layer turns of the conductive wire are fit in grooves each of which is formed between outer peripheries of a respective two of the first layer turns which are arranged adjacent to each other in the first direction. This causes the second layer turns to be wound at constant intervals away from each other around a corresponding one of the teeth. Similarly, the third or subsequent layer turns of the conductive wire are fit in grooves each of which is formed between outer peripheries of a respective adjacent two of the turns last wound around the tooth, so that they are positioned at constant intervals away from each other in the first direction.

Generally, when a conductive wire is wound in the form of a multiple layers of turns to make the coil, a radially outermost surface of a second or subsequent one of the layers will be located farther away from an outer peripheral surface of a tooth with an increase in diameter of the conductive wire. Additionally, a distance between each of axially opposed ends of each layer of the turns of the coil and the center of the coil in the first direction will increase with an increase in diameter of the conductive wire unless the number of turns of the conductive wire of each layer is changed. The contact surface of each of the stopper protrusions is, as described already, oriented to slant, as viewed along the reference axis, to have the second end which is far away from the tooth and located farther away from the coil than the first end is in a direction perpendicular to the first direction. In other words, the contact surface of each of the stopper protrusions is inclined to have the distance between a portion of the contact surface and the center of the coil in the first direction which increases with an increase in distance of the portion of the contact surface from the tooth in a direction perpendicular to the first direction. The above orientation of the contact surface enables the conductive wire to be wound around the tooth to have the same number of turns without having to modify the insulator even when the diameter of the conductive wire is changed. The above orientation of the contact surface of each of the stopper protrusions also ensures the stability in contacting ends of each of third or subsequent odd-numbered layers of the turns which are opposed to each other in the first direction regardless of a change in diameter of the conductive wire.

For instance, use of an insulator without stopper protrusions may result in an air gap appearing between the insulator and an end of one of n^{th} odd-numbered layers of turns of a conductive wire in the first direction depending upon the diameter of the conductive wire. The insulators in the above structure each include the stopper protrusions, thereby minimizing a risk that an air gap may be created between each of the insulators and an end of one of odd-numbered layers of turns of the conductive wire in the first direction. The contact surface is, as described above, arranged in contact with the end of a corresponding one of third or subsequent odd-numbered layers of turns of the conductive wire in the first direction, thereby stopping such an end from moving away from the center of the coil in the first direction. In other words, the insulators in the above structure serve to minimize a risk of deformation of the coils regardless of a change in diameter of the conductive wire.

The above structure of each of the insulators, therefore, enables the conductive wire to be wound around the tooth to produce the first layer turns which are arranged at constant intervals away from each other in the first direction in spite of a change in diameter of the conductive wire. Additionally, the contact surface of each of the stopper protrusions serves to minimize a risk of deformation of more than second odd-numbered layers of the turns of the conductive wire in spite of a change in diameter of the conductive wire. This eliminates the need for modifying the design of the insulators even when the diameter of the conductive wire is changed and ensures a required configuration of the coils, thereby minimizing a variation in required types of the insulators.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is a schematic illustration of an electrical motor equipped with a stator according to an embodiment;

FIG. 2 is a perspective view which illustrates a core segment and an insulator of the stator shown in FIG. 1;

FIG. 3 is a perspective view which illustrates an insulator installed in the stator shown in FIG. 1;

FIG. 4 is a perspective view which illustrates an insulator installed in the stator shown in FIG. 1;

FIG. 5 is a plan view which illustrates an insulator installed in the stator shown in FIG. 1;

FIG. 6 is a plan view which illustrates a portion of an insulator installed in the stator shown in FIG. 1;

FIG. 7 is a plan view which illustrates a core segment around which a coil is wound and installed in the stator shown in FIG. 1;

FIG. 8 is a plan view which illustrates a portion of a core segment around which a coil is wound and installed in the stator shown in FIG. 1;

FIG. 9 is a plan view which illustrates a portion of a core segment around which a coil is wound and installed in the stator shown in FIG. 1;

FIG. 10 is a plan view which illustrates a portion of a core segment around which a coil is wound and installed in the stator shown in FIG. 1;

FIG. 11 is a plan view which illustrates a portion of a core segment which is installed in the stator shown in FIG. 1 and around which a coil is wound;

FIG. 12 is a plan view which illustrates a portion of a stator in a first modified form; and

FIG. 13 is a plan view which illustrates a portion of a stator in a second modified form.

### MODE FOR CARRYING OUT THE INVENTION

One embodiment of a stator will be described below. For the sake of convenience, some of the drawings exaggerate or simplify portions of a structure of the stator. The drawings may be different in ratio of dimensions of parts of the stator among them. The term “orthogonal” or “perpendicular” referred to in this disclosure does not necessarily mean that one member is at right angles to another member, but contains the meaning that one member is oriented substantially or nearly perpendicular to another member within an angular range which offers the required beneficial effects in the embodiment. The term “circular” or “annular” referred to in this disclosure means a loop having, e.g., a continuous profile with no slit or gap or a discontinuous profile, such as C-shape. The term “circular” or “annular” also contains a round shape, an oval shape, or a polygonal shape with a sharp or a round corner(s), however, is not necessarily limited thereto. The term “at least one” referred to in this disclosure expresses one or more numeral selected from desired options. Specifically, if there are two options, the term “at least one” means only one or all of the options. If there are three options, the term “at least one” expresses only one or selected two or more of the options. This disclosure is not limited to such examples, but contains equivalents or modifications of members which are recited in claims or discussed in the following embodiments.

### Overall Structure of Motor 50

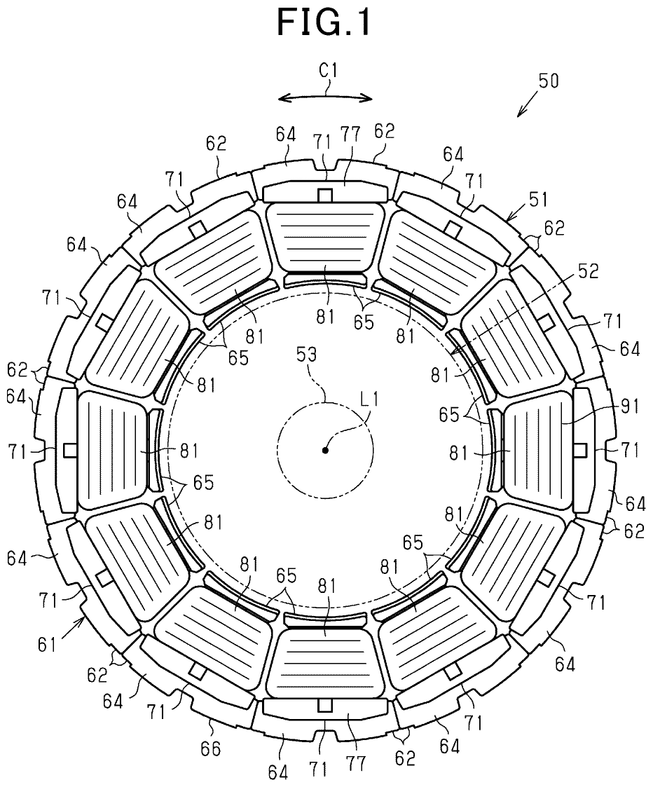

The electrical motor 50, as illustrated in FIG. 1, includes the stator 51 and the rotor 52. The stator 51 is of an annular shape. The rotor 52 is arranged inside the stator 51. The rotor 52 includes the rotating shaft 53.

### Structure of Stator 51

The stator 51 includes the stator core 61, the insulators 71 and a plurality of coils 81.

### Structure of Stator Core 61

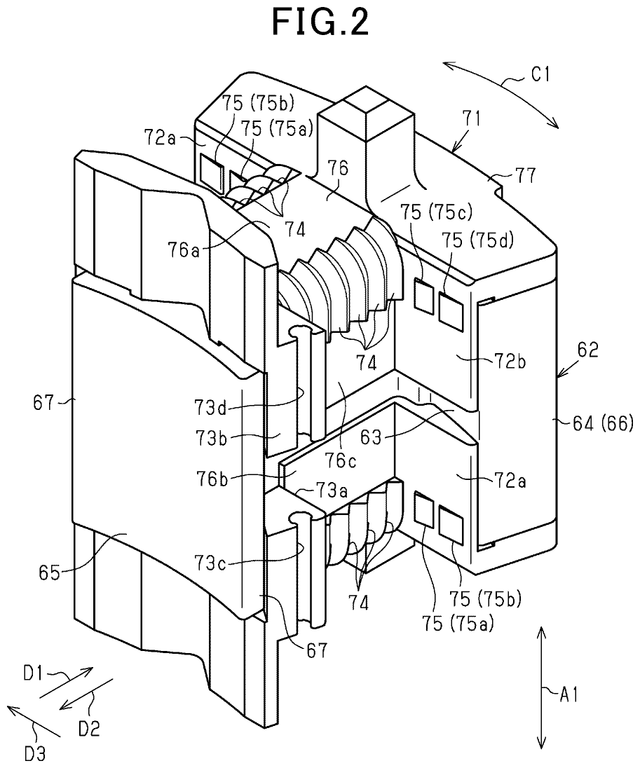

The stator core 61, as can be seen in FIGS. 1 and 2, includes a plurality of core segments 62 arranged adjacent to each other in a circumferential direction of the stator 51. Specifically, the stator core 61 is made by twelve core segments 62. Each of the core segments 62 is made from a magnetic metal material. Each of the core segments 62 includes the back yoke 64 with the first surface 63 and the tooth 65 protruding from the first surface 63 in a direction perpendicular to the reference axis L1. The reference axis L1 is defined to coincide with the center of rotation of the rotating shaft 53 of the motor 50. The reference axis L1 also coincides with the center axis of the stator core 61. In the following discussion, a direction along the reference axis L1 will be referred to below as the axial direction A1.

The core segments 62 of the stator core 61 are arranged in a circular form centered at the reference axis L1. The core segments 62 are also arrayed in the circumferential direction C1 around the reference axis L1 to have the back yokes 64 of the core segments 62 which are arranged in an annular form as a whole. The circumferential direction C1, as referred to herein, is a circumferential direction of the stator 51. The back yokes 64 of the twelve core segments 62 define the annular member 66 centered at the reference axis L1. The first surfaces 63 of the back yokes 64 define an inner peripheral surface of the annular member 66. In other words, the annular member 66 has the first surfaces 63. The first surfaces 63 extend along the reference axis L1.

The core segments 62 are arranged adjacent to each other in the circumferential direction C1 to have the first surfaces 63 defining radially inner surfaces of the back yokes 64. The radial direction, as referred to herein, is a direction perpendicular to the reference axis L1, in other words, orthogonal to the circumferential direction C1. Each of the teeth 65 is oriented to protrude from a corresponding one of the back yokes 64 a radially inward direction. Each of the teeth 65 extends in the radial direction and has a top end defining a radially inner end. Each of the teeth 65 also has a base end defining a radially outer end. Each of the teeth 65 has circumferential protrusions 67 which extend from the top end away from each other in the circumferential direction C1.

### Structures of Insulators 71 and Coils 81

Each of the teeth 65 has one of the insulators 71 fit thereon. Each of the teeth 65 has the coil 81 disposed therearound through the insulator 71. Specifically, each of the coils 81 is made by the single conductive wire 91 wound around a corresponding one of the teeth 65 through the insulator 71 in the form of three or more layers stacked one another. Two or more of the coils 81 may alternatively be produced continuously by the single conductive wire 91. For instance, each of the coils 81 is made by winding the conductive wire 91 around a corresponding one of the teeth 65 through the insulator 71 into the form of five layers. The number of layers of the conductive wire 91 stacked one another around each of the coils 81 may be, as described above, three or more. The conductive wire 91 is circular in transverse section thereof and may be made of an electrically insulating wire.

Each of the insulators 71 serves to electrically isolate the coil 81 on the tooth 65 from the stator 51. Each of the insulators 71 is made from an electrically insulating resin. For instance, each of the insulators 71 is molded using resin. Two of the insulators 71 are fit on end portions of each of the core segments 62 which are opposed to each other in the axial direction A1. Two of the insulators 71 fit on each of the core segments 62 are identical in configuration with each other.

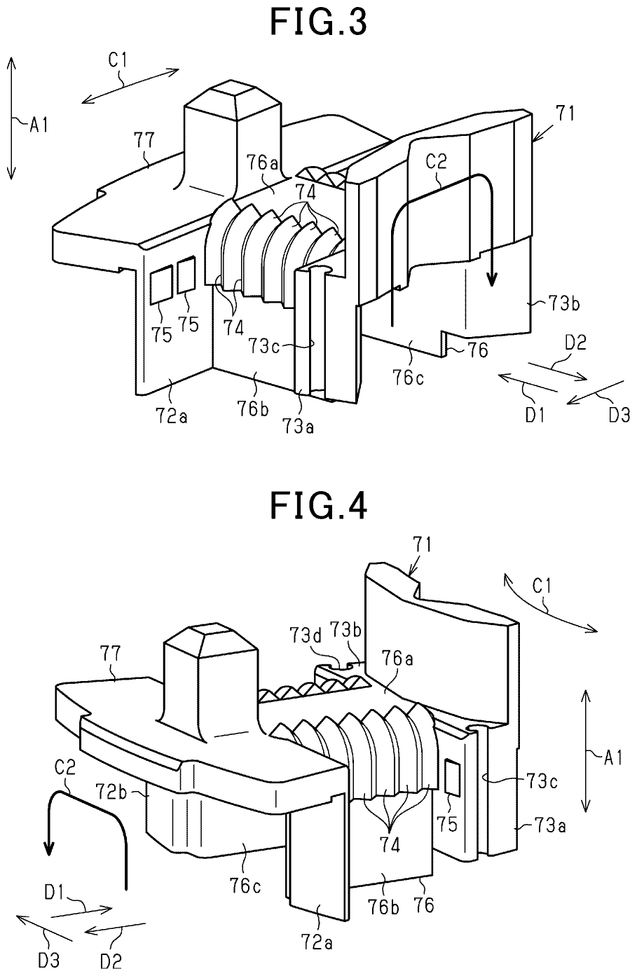

Each of the insulators 71, as illustrated in FIGS. 2 to 5, includes first adjacent walls 72a and 72b, the second adjacent walls 73a and 73b, a plurality of retention grooves 74, and a plurality of stopper protrusions 75. Each of the insulators 71 also includes the tooth cover 76 which covers at least a portion of an outer circumferential surface of the insulator 71. Each of the insulators 71 also may include the yoke-end-surface cover 77 which covers a portion of an end surface of the annular member 66 which faces in the axial direction A1. Specifically, the yoke-end-surface cover 77 covers at least a portion of an end surface of the back yoke 64 which faces in the axial direction A1. For instance, each of the insulators 71 is produced by a single unit made up of the first adjacent walls 72a and 72b, the second adjacent walls 73a and 73b, the stopper protrusions 75, the tooth cover 76, and the yoke-end-surface cover 77 which are formed integrally with each other.

The tooth cover 76 of each of the insulators 71 includes the end surface cover 76a and the side surface covers 76b and 76c. The end surface cover 76a covers one of end surfaces of the tooth 65 which are opposed to each other in the axial direction A1. The side surface covers 76b and 76c cover side surfaces of the tooth 65 which are opposed to each other in the circumferential direction C1. The side surface covers 76b and 76c extend in the axial direction A1 from edges of the end surface cover 76a which are opposed to each other in the circumferential direction C1.

Each of the insulators 71 has the retention grooves 74 formed in the tooth cover 76. The retention grooves 74 of each of the insulators 71 include six grooves extending over the side surface cover 76b and end surface cover 76a and six grooves extending over the side surface cover 76c and the end surface cover 76a. In the following discussion, the six retention grooves 74 extending over the side surface cover 76b and the end surface cover 76a will be referred to as the retention grooves 74a to 74f. The six retention grooves 74 extending over the side surface cover 76c and the end surface cover 76a will be referred to as the retention grooves 74g to 74l.

The retention grooves 74a to 74f are arranged adjacent to each other in line in the first direction D1 from the top end to the base end of the tooth 65. The retention grooves 74a to 74f are located at equal intervals away from each other in the first direction D1. Similarly, the retention grooves 74g to 74l are arranged adjacent to each other in line in the first direction D1. The retention grooves 74g to 74l are located at equal intervals away from each other in the first direction D1. A direction from the base end to the top end of each of the teeth 65 coincides with the second direction D2.

Each of the retention grooves 74a to 74f extends both in a first end region including a first one of edges of the end surface cover 76a which are opposed to each other in the circumferential direction C1 and in a second end region of the side surface cover 76b which continues from the first end region in the axial direction A1. The first one of the edges of the end surface cover 76a is located close to the side surface cover 76b. In other words, the retention grooves 74a to 74f occupy a region including a corner of the tooth cover 76 which lies between the end surface cover 76a and the side surface cover 76b.

Each of the retention grooves 74g to 74l extends both in a third end region including a second one of the edges of the end surface cover 76a which are opposed to each other in the circumferential direction C1 and in a fourth end region of the side surface cover 76c which continues from the third end region in the axial direction A1. The second one of the edges of the end surface cover 76a is located close to the side surface cover 76c. In other words, the retention grooves 74g to 74l occupy a region including a corner of the tooth cover 76 which lies between the end surface cover 76a and the side surface cover 76c.

The retention grooves 74 are shaped to extend in the winding direction C2 in which the coils 81 are wound around the teeth 65. The winding direction C2, as referred to therein, is a direction in which the conductive wire 91 of each of the coils 81 is wound around a corresponding one of the teeth 65. A corresponding portion of the side surface cover 76b or 76c in which each of the retention grooves 74 is formed extends in the axial direction A1. A corresponding portion of the end surface cover 76a in which each of the retention grooves 74 is formed extends orthogonal both to the first direction D1 and to the reference axis L1, as viewed in the axial direction A1.

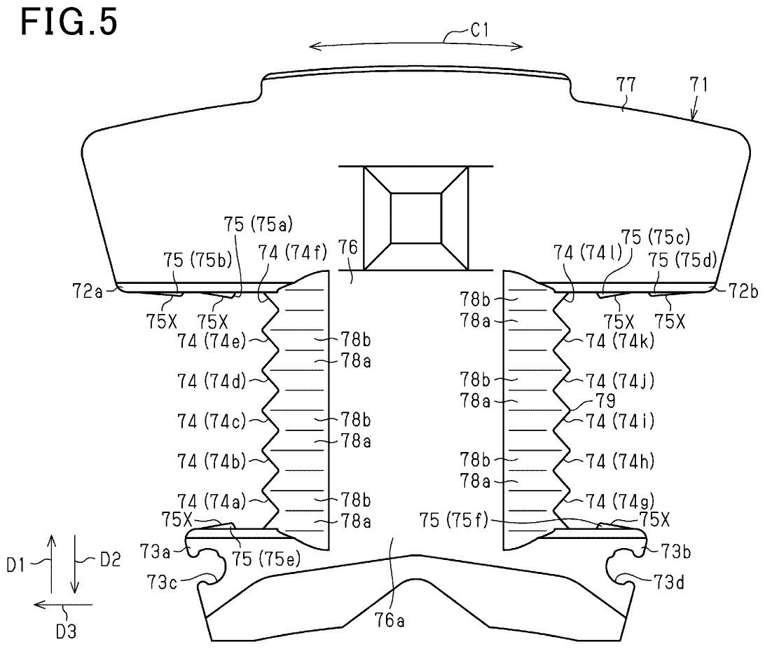

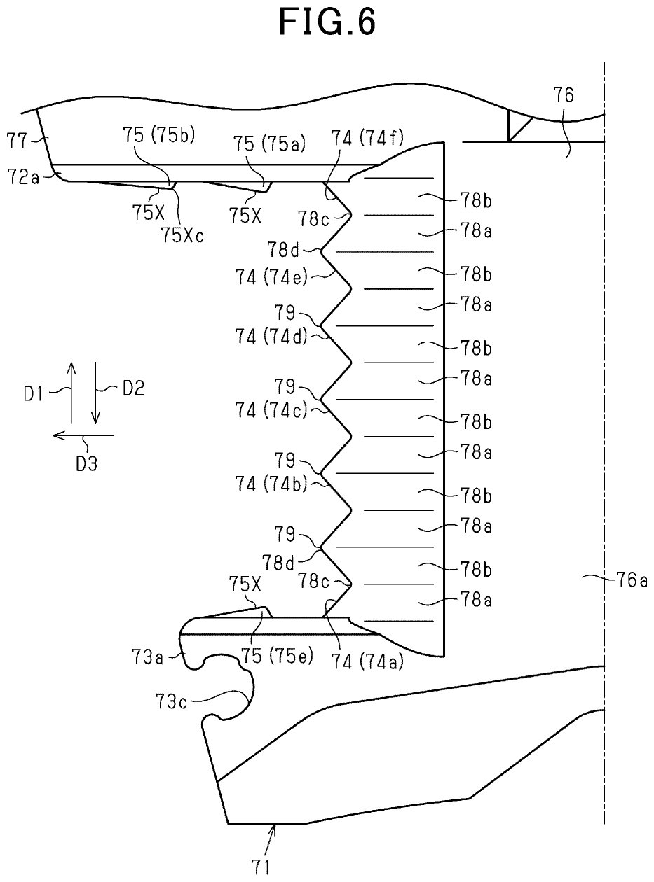

Each of the retention grooves 74, as can be seen in FIGS. 5 and 6, has a pair of holding surfaces 78a and 78b which face each other in the first direction D1. The holding surface 78b of each of the retention grooves 74 is located away from the holding surface 78a thereof in the first direction D1. The holding surface 78a and the holding surface 78b of each of the retention grooves 74 are oriented to slant relative to each other in the first direction D1 to have a distance therebetween in the first direction D1 which increases from the bottom 78c toward the opening 78d. Each of the holding surfaces 78a and 78b is, therefore, not orthogonal to the first direction D1. Each of the holding surfaces 78a and 78b is also not parallel to the first direction D1.

Each of the retention grooves 74 is of a V-shape in transverse section thereof. In other words, each of the retention grooves 74 has a width, as defined in the first direction D1, which increases from the bottom 78c toward the opening 78d. The transverse section of each of the retention grooves 74, as referred to herein, is a cross section thereof extending in a direction perpendicular to the length of the retention groove 74. The transverse section of each of the retention grooves 74 may alternatively be of, for example, a trapezoidal shape. The bottom 78c of each of the retention grooves 74 may be of any shape, such as a circular or planar shape extending in the first direction D1.

Each of the tooth covers 76 includes the ridges or protrusions 79 each of which is formed between a respective two of the retention grooves 74 which are adjacent to each other in the first direction D1. In other words, each of the protrusions 79 is defined by a portion of the tooth cover 76 which is located between the holding surface 78a and the holding surface 78b of a respective two of the retention grooves 74 which are adjacent to each other in the first direction D1. For instance, the protrusion 79 between the retention groove 74a and the retention groove 74b is formed by a portion of the tooth cover 76 between the holding surface 78b of the retention grooves 74a and the holding surface 78a of the retention grooves 74b. Each of the protrusions 79 may be shaped to have a round tip or apex. For example, the top of each of the protrusions 79 is curved or rounded in a convex shape. Each of the protrusions 79 projects to have the top thereof in the same direction as that from the bottom 78c toward the opening 78d of the retention groove 74.

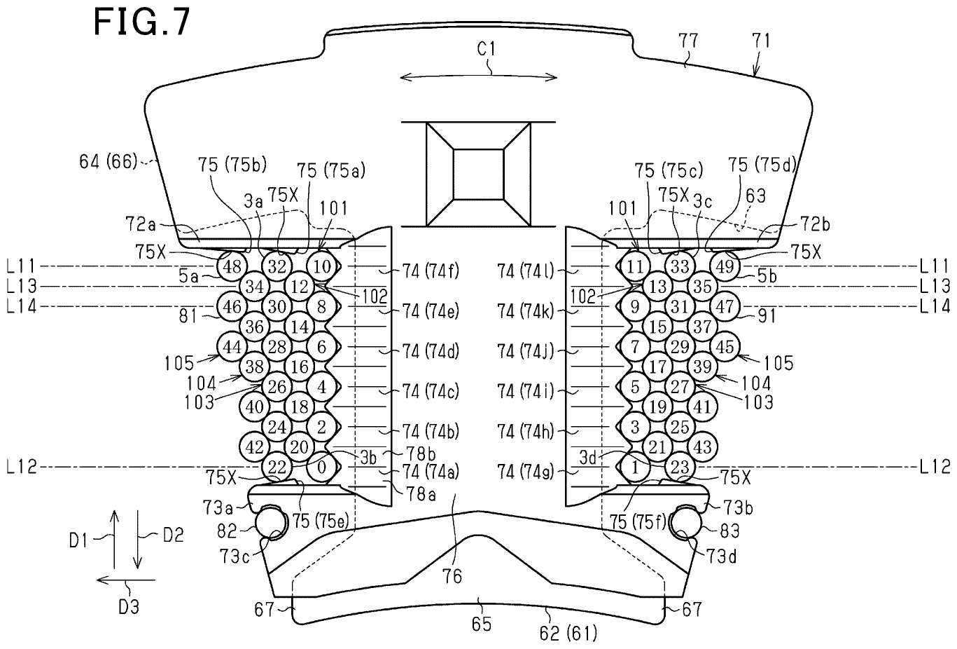

Each of the coils 81, as can be seen in FIG. 7, includes the first terminal section 82 and the second terminal section 83. The first terminal section 82 is a portion of the conductive wire 91 including a winding start section (i.e., a leading section) thereof. The second terminal section 83 is a portion of the conductive wire 91 including a winding end section (i.e., a trailing section) thereof.

FIGS. 7 to 11 illustrate a cross section of each of the coils 81 cut perpendicular to the reference axis L1, i.e., the axial direction A1. The reference axis L1 shown in FIG. 1 is omitted in FIGS. 7 to 11 for the brevity of illustration. The axial direction A1 in each of FIGS. 7 to 11 is a direction orthogonal to the surface of the drawing. FIGS. 7 to 11 omit hatching denoting the cross section of the coil 81. Reference numbers 0 to 49 labeled in the cross section of the coil 81 in FIGS. 7 to 9 represent examples of locations of turns of the conductive wire 91 and the order of the conductive wire 91 is wound to make the turns. In other words, the conductive wire 91 of each of the coils 81 is wound around a corresponding one of the teeth 65 in the order of 1 to 49. As viewed in the first direction D1 in this embodiment, the conductive wire 91 is wound around the tooth 65 in a counterclockwise direction, but may be wound in a clockwise direction. Each of the coils 81 has portions which overlap with, i.e., are arranged directly adjacent to a corresponding one of the teeth 65 in the circumferential direction C1 extend in the axial direction A1.

The turns of the conductive wire 91 of each of the coils 81 are, as can be seen in FIG. 7, fit in the retention grooves 74 of the insulator 71 in the form of a first one (i.e., an innermost one) of the multiple layers. In the following discussion, the first layer of the turns of each of the coils 81 will also be referred to as the first layer 101. The turns of each of the coils 81 making the first layer 101 (which will also be referred to below as first layer turns) are, as clearly illustrated in FIG. 7, at the locations denoted by the reference numbers 0 to 11. The turns of each of the coils 81 making the first layer 101 are placed in direct contact with the holding surfaces 78a and 78b of the retention grooves 74 and thereby held from moving in the first direction D1. The retention grooves 74 are, as described above, arranged at equal intervals away from each other in the first direction D1, thereby arranging the turns of the conductive wire 91 of the first layer 101 at constant intervals away from each other around of the tooth 65.

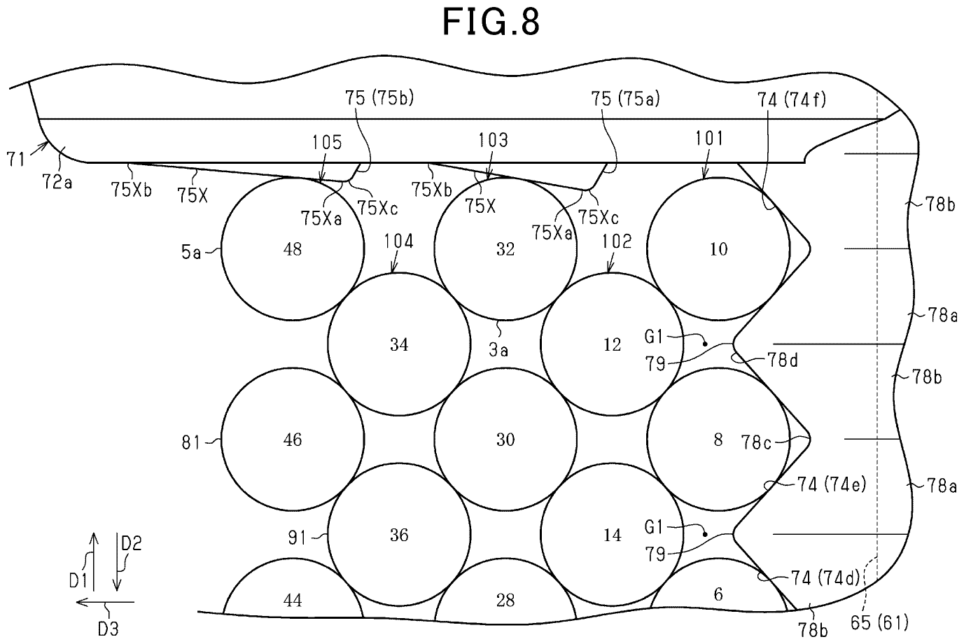

The retention grooves 74 which are arranged adjacent to each other in the first direction D1 work to retain the turns of the conductive wire 91 of the first layer 101 to be arranged away from each other through the air gap G1, as illustrated in FIG. 8, in the first direction D1. In other words, the retention grooves 74 are arranged away from each other in the first direction D1 to locate the turns of the conductive wire 91 of the first layer 101 at an interval away from each other which is identical with the size of the air gap G1.

The turns of each of the coils 81 stacked on the first layer 101 create the second layer 102. The second layer 102 is located radially outside the outer periphery of the first layer 101. The turns of the conductive wire 91 of the second layer 102 (which will also be referred to below as second layer turns) are at locations denoted by reference numbers 12 to 21. The second 20) layer turns of each of the coils 81 are fit in grooves each of which is defined by outer peripheral surfaces of a respective two of the first layer turns which are arranged adjacent to each other through the air gap G1 in the first direction D1. For instance, the turn of the conductive wire 91 of the second layer 102 which is at the location denoted by the reference number 12 is fit in a groove created between the turn of the first layer 101 at the location denoted by the reference number 8 and the turn of the first layer 101 at the location denoted by the reference number 10. The turn of the second layer 102 at the location denoted by the reference number 12 is, therefore, positioned or held from moving in the first direction D1 by the turns of the conductive wire 91 at the locations denoted by the reference numbers 8 and 10. As an example, the turn of the conductive wire 91 denoted by the reference number 12 is arranged at the center of an interval between the turns of the conductive wire 91, as denoted by the reference numbers 8 and 10, in the first direction D1. Similarly, the turns of the conductive wire 91 denoted by the reference numbers 13 to 21 are held from moving in the first direction D1 by the turns of the conductive wire 91 of the first layer 101. Accordingly, the turns of the conductive wire 91 of the second layer 102 are positioned by the turns of the conductive wire 91 of the first layer 101 relative to the insulator 71 in the first direction D1, thereby causing the conductive wire 91 of the second layer 102 to be wound around the outer periphery of the first layer 101 in the form of turns located at a constant interval away from each other in the first direction D1 around the tooth 65.

Turns of the conductive wire 91 of each of the coils 81 which are located outside the second layer 102 are also arranged in the form of the third layer 103, the fourth layer 104, and the fifth layer 105. The turns of the third layer 103, the fourth layer 104, and the fifth layer 105 are, like the second layer 102, fit in grooves between respective adjacent turns of an adjacent one of the second to fourth layers 102 to 104. The turns of the third layer 103, the fourth layer 104, and the fifth layer 105, therefore, have portions which are placed in direct contact with a respective two of the turns of an adjacent one of the second to fourth layers 102 to 104 which are arranged adjacent to each other in the first direction D1, so that they are positioned or held from moving in the first direction D1.

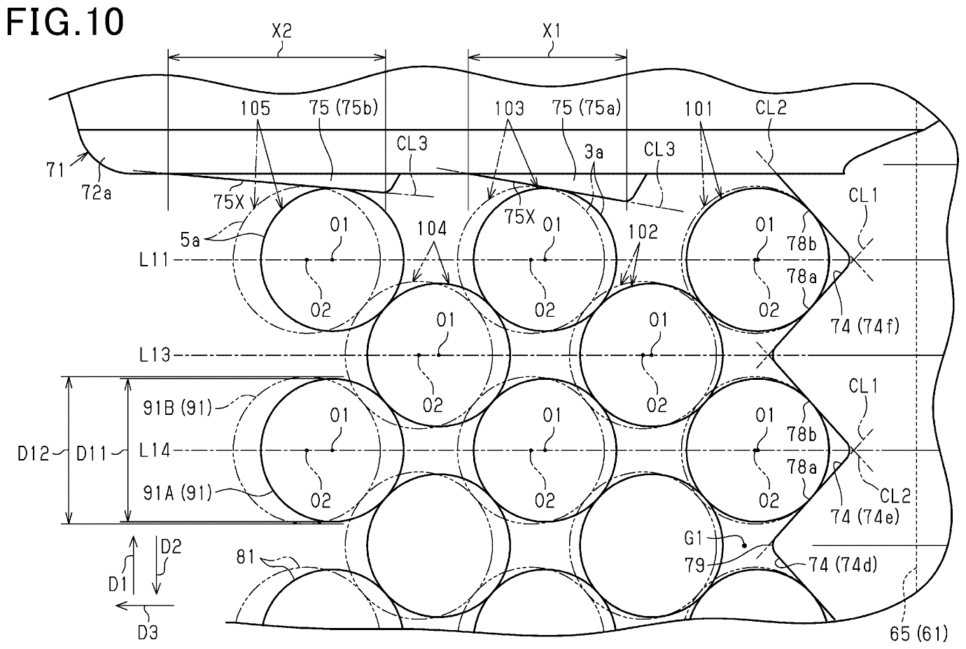

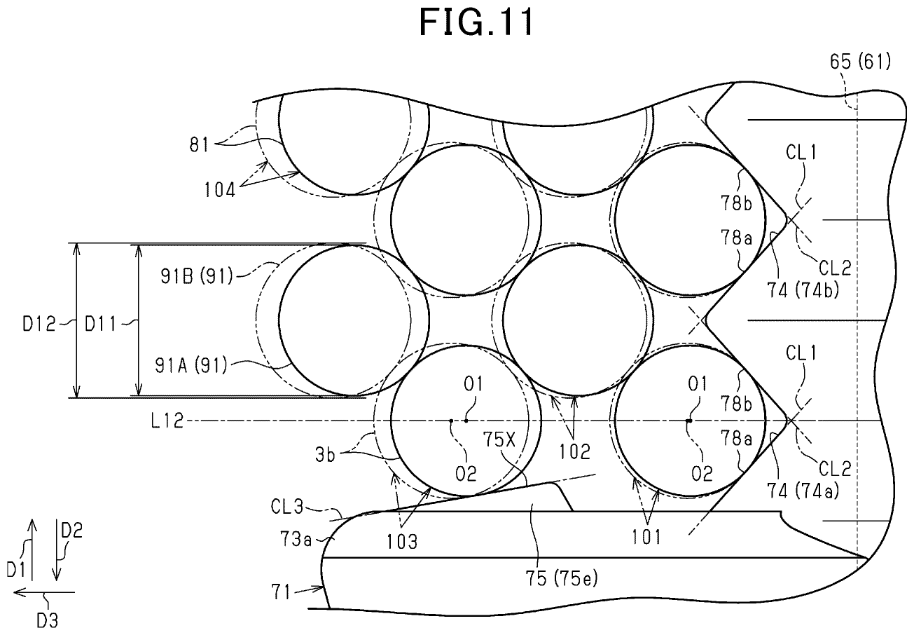

The conductive wire 91 has a diameter which may be, as can be seen in FIGS. 10 and 11, optionally selected depending upon specifications of the motor 50 as long as it is great enough to retain the turns of the conductive wire 91 by the retention grooves 74. In other words, the retention grooves 74 are capable of retaining a plurality of types of turns of the conductive wire 91 which are different in diameter from each other. The stability in retaining turns of the conductive wire 91 in each of the retention grooves 74 is achieved by selecting the diameter of the turns to have an outer peripheral surface of each of the turns which makes physical contact with the holding surfaces 78a and 78b of the retention groove 74. The diameter of the conductive wire 91 is also preferably selected to have the turns of the second layer 102 each of which is in physical contact with the turns of the conductive wire 91 fit in a respective two of the retention grooves 74 arranged adjacent to each other in the first direction D1 and disposed in a groove created between those turns fit in the retention grooves 74.

FIGS. 10 and 11 show turns of the coil 81 produced by the first conductive wire 91A using solid lines. The first conductive wire 91A has the first diameter D11. FIGS. 10 and 11 also show turns of the coil 81 produced by the second conductive wire 91B using dash-double-dot lines. The second conductive wire 91B has the second diameter D12 different from the first diameter D11. The second diameter D12 is greater than the first diameter D11. FIGS. 7 to 9 illustrate only the turns of the coil 81 produced by the first conductive wire 91A.

The holding surface 78a of each of the retention grooves 74 is a surface containing the common line CL1 of tangent both to a first peripheral surface and to a second peripheral surface, as viewed in a transverse section of the retention groove 74. The first peripheral surface is an outer surface of the first conductive wire 91A contacting directly with the holding surface 78a when the first conductive wire 91A is wound around the tooth 65 through the insulator 71. The second peripheral surface is an outer surface of the second conductive wire 91B contacting directly with the holding surface 78a when the second conductive wire 91B is wound around the tooth 65 through the insulator 71. The holding surface 78b of each of the retention grooves 74 is a surface containing the common line CL2 of tangent both to a third peripheral surface and to a fourth peripheral surface, as viewed in a transverse section of the retention groove 74. The third peripheral surface is an outer surface of the first conductive wire 91A contacting directly with the holding surface 78b when the first conductive wire 91A is wound around the tooth 65 through the insulator 71. The fourth peripheral surface is an outer surface of the second conductive wire 91B contacting directly with the holding surface 78b when the second conductive wire 91B is wound around the tooth 65 through the insulator 71. In other words, each of the holding surfaces 78a and 78b of a respective one of the retention grooves 74 is shaped to have a first line of tangent to the outer peripheral surface of the first conductive wire 91A fit in the retention groove 74 and a second line of tangent to the outer peripheral surface of the second conductive wire 91B fit in the retention groove 74. The first line coincides with the second line, as viewed in a transverse section of the retention groove 74.

Referring back to FIG. 7, the first adjacent walls 72a and 72b of each of the insulators 71 are located away from or adjacent directly to the coil 81 in the first direction D1 and cover at least a portion of the first surface 63 of the back yoke 64. Each of the first adjacent walls 72a and 72b faces the coil 81 in the first direction D1. Each of the insulators 71 has the first adjacent walls 72a and 72b arranged on sides of a corresponding one of the teeth 65, as viewed in the axial direction A1, which are opposed to each other in a direction perpendicular both to the first direction D1 and the axial direction A1. The tooth cover 76 of each of the insulators 71 is arranged between the first adjacent wall 72a and the first adjacent wall 72b in the circumferential direction C1. The first adjacent walls 72a and 72b of each of the insulators 71 extend in opposite directions (i.e., the circumferential direction C1) away from the base end of the tooth cover 76, i.e., an end of the tooth cover 66 which is located farther away from the top end thereof in the first direction D1. When each of the insulators 71 is fit on a corresponding one of the teeth 65, the first adjacent walls 72a and 72b cover the first surface 63 on sides of the tooth 65 opposed to each other in the circumferential direction C1.

Each of the second adjacent walls 73a and 73b of the insulator 71 is located away from the coil 81 in the second direction D2 and adjacent to the coil 81 in the second direction D2. Each of the second adjacent walls 73a and 73b is oriented to face the coil 81 in the second direction D2. Each of the insulators 71 has the second adjacent walls 73a and 73b which are respectively arranged on sides of the tooth 65, as viewed in the axial direction A1, opposed to each other in a direction perpendicular both to the first direction D1 and to the axial direction A1. The tooth cover 76 of each of the insulators 71 is arranged between the second adjacent wall 73a and the second adjacent wall 73b in the circumferential direction C1. The second adjacent walls 73a and 73b of each of the insulators 71 extend in opposite directions (i.e., the circumferential direction C1) away from the top end of the tooth cover 76, i.e., an end of the tooth cover 66 which is located farther away from the base end thereof in the second direction D2. When each of the insulators 71 is fit on a corresponding one of the teeth 65, the second adjacent walls 73a and 73b are located between the circumferential protrusion 67 and the coil 81 in the second direction D2 and also located on sides of the tooth 65 opposed to each other in the circumferential direction C1.

The second adjacent wall 73a may have the first provisional retention groove 73c formed therein. For instance, the first provisional retention groove 73c is, as clearly illustrated in FIG. 7, located in an end portion of the second adjacent wall 73a facing in the circumferential direction C1. The first provisional retention groove 73c extends through the second adjacent wall 73a in the axial direction A1. The first provisional retention groove 73c has an opening facing away from the second adjacent wall 73b in the circumferential direction C1. Similarly, the second adjacent wall 73b may have the second provisional retention groove 73d formed therein. For instance, the second provisional retention groove 73d is, as clearly illustrated in FIG. 7, located in an end portion of the second adjacent wall 73b facing in the circumferential direction C1. The second provisional retention groove 73d extends through the second adjacent wall 73b in the axial direction A1. The second provisional retention groove 73d has an opening facing away from the second adjacent wall 73a in the circumferential direction C1.

When the first terminal section 82 is disposed in the first provisional retention groove 73c so that it passes through the first provisional retention groove 73c in the axial direction A1, the first terminal section 82 is temporarily held by the insulator 71. Similarly, when the second terminal section 83 is disposed in the second provisional retention groove 73d so that is passes through the second provisional retention groove 73d in the axial direction A1, the second terminal section 83 is temporarily held by the insulator 71. The yoke-end-surface cover 77 may alternatively have the first provisional retention groove 73c and the second provisional retention groove 73d formed therein.

The stopper protrusions 75 of each of the insulators 71 bulge from the first adjacent walls 72a and 72b and/or the second adjacent walls 73a and 73b toward the coil 81. In this embodiment, the stopper protrusion 75 are formed on each of the first adjacent walls 72a and 72b. For instance, each of the insulators 71 has two stopper protrusions 75 formed on the first adjacent wall 72a and also has two stopper protrusions 75 formed on the first adjacent wall 72b. Each of the insulators 71 may have the stopper protrusion 75 bulging from the second adjacent walls 73a and 73b. For instance, each of the insulators 71 may have the single stopper protrusion 75 formed on the second adjacent wall 73a and also have the single stopper protrusion 75 formed on the second adjacent wall 73b. In the following discussion, the stopper protrusions 75 formed on the first adjacent wall 72a will be referred to as the stopper protrusion 75a and 75b. The stopper protrusions 75 formed on the first adjacent wall 72b will be referred to as the stopper protrusion 75c and 75d. The stopper protrusion 75 formed on the second adjacent wall 73a will be referred to as the stopper protrusion 75e. The stopper protrusion 75 formed on the second adjacent wall 73b will be referred to as the stopper protrusion 75f. The stopper protrusion 75a to 75d of each of the insulators 71 are shaped to protrude from the first adjacent walls 72a and 72b in the first direction D1. The stopper protrusion 75e and 75f of each of the insulators 71 are shaped to protrude from the second adjacent walls 73a and 73b in the second direction D2.

Each of the stopper protrusions 75a to 75f, as can be seen in FIGS. 7 to 9, has the contact surface 75X which makes physical contact with a first portion or a second portion of one of turns of the conductive wire 91 which make third or subsequent odd-numbered layers of the coil 81. The first portion and the second portion of the turn are opposed to each other in the first direction D1. A surface of each of the stopper protrusions 75a to 75f which faces in a direction in which the stopper protrusion 75a to 75f bulge defines the contact surface 75X. The contact surface 75X of each of the stopper protrusions 75a to 75f has the first end 75Xa and the second end 75Xb opposed to each other in a direction perpendicular both to the first direction D1 and to the axial direction A1, as viewed in the axial direction A1. The first end 75Xa is located closer to the tooth 65 than the second end 75Xb is. The contact surface 75X is inclined to have the second end 75Xb located farther away from the coil 81 than the first end 75Xa is in the first direction D1. In other words, each of the stopper protrusions 75a to 75f is oriented to have a distance, as defined from the surface of the insulator 71 when viewed in the axial direction A1, which creases toward the tooth 65 in a direction perpendicular to the first direction D1 and to the axial direction A1. The contact surface 75X of each of the stopper protrusions 75a to 75f is, therefore, oriented to slant, as viewed in the axial direction A1, relative to the direction perpendicular to the first direction D1 and the axial direction A1. In the following discussion, the direction perpendicular both to the first direction D1 and to the axial direction A1 will also be referred to below as the third direction D3.

Each of the stopper protrusions 75a to 75f extends in the axial direction A1. Each of the stopper protrusions 75a to 75f is of a triangular shape, as viewed in the axial direction A1. The contact surface 75X of each of the stopper protrusions 75a to 75f is a planar surface extending parallel to the axial direction A1.

The third layer turns which form the third layer 103 of each of the coils 81, as can be seen in FIG. 7, include the third-layer-end portions 3a, 3b, 3c, and 3d located at ends of the third layer 103 in a transverse section of the coil 81, as cut in the first direction D1. The third-layer-end portions 3a to 3d extend in the axial direction A1 on sides of the tooth 65 opposed to each other in the third direction D3. The third-layer-end portions 3a and 3b are located between the first adjacent wall 72a and the second adjacent wall 73a. The third-layer-end portion 3a is defined by one of turns of the conductive wire 91 which is at a location denoted by the reference number 32. The third-layer-end portion 3b is defined by one of turns of the conductive wire 91 which is at a location denoted by the reference number 22. The third-layer-end portions 3c and 3d are located between the first adjacent wall 72b and the second adjacent wall 73b. The third-layer-end portion 3c is defined by one of turns of the conductive wire 91 which is at a location denoted by the reference number 33. The third-layer-end portion 3d is defined by one of turns of the conductive wire 91 which is at a location denoted by the reference number 23.

The contact surface 75X of the stopper protrusion 75a is placed in direct contact with the third-layer-end portion 3a. The third-layer-end portion 3a contacts both with the contact surface 75X of the stopper protrusion 75a and with one of the turns of the conductive wire 91 which is at a location denoted by the reference number 12. The contact surface 75X of the stopper protrusion 75a works to stop the third-layer-end portion 3a from moving relative to the insulator 71 in the first direction D1. One of the turns of the conductive wire 91 which is at a location denoted by the reference number 12 works to stop the third-layer-end portion 3a from moving away from the insulator 71 in a direction opposite the first direction D1, that is, in the second direction D2. The third-layer-end portion 3a is, therefore, positioned in the first direction D1 by the contact surface 75X of the topper protrusion 75a and the turn of the conductive wire 91 which is at a location denoted by the reference number 12.

The contact surface 75X of the stopper protrusion 75e is placed in direct contact with the third-layer-end portion 3b. The third-layer-end portion 3b contacts both with the contact surface 75X of the stopper protrusion 75e and with one of the turns of the conductive wire 91 which is at a location denoted by the reference number 20. The contact surface 75X of the stopper protrusion 75e works to stop the third-layer-end portion 3b from moving relative to the insulator 71 in the second direction D2. One of the turns of the conductive wire 91 which is at a location denoted by the reference number 20 works to stop the third-layer-end portion 3b from moving relative to the insulator 71 in the first direction D1. The third-layer-end portion 3b is, therefore, positioned in the first direction D1 by the contact surface 75X of the topper protrusion 75e and the turn of the conductive wire 91 which is at a location denoted by the reference number 20.

The contact surface 75X of the stopper protrusion 75c is placed in direct contact with the third-layer-end portion 3c. The third-layer-end portion 3c contacts both with the contact surface 75X of the stopper protrusion 75c and with one of the turns of the conductive wire 91 which is at a location denoted by the reference number 13. The third-layer-end portion 3c is, like the third-layer-end portion 3a, positioned in the first direction D1 by the contact surface 75X of the topper protrusion 75c and the turn of the conductive wire 91 which is at a location denoted by the reference number 13.

The contact surface 75X of the stopper protrusion 75f is placed in direct contact with the third-layer-end portion 3d. The third-layer-end portion 3d contacts both with the contact surface 75X of the stopper protrusion 75c and with one of the turns of the conductive wire 91 which is at a location denoted by the reference number 21. The third-layer-end portion 3d is, like the third-layer-end portion 3b, positioned in the first direction D1 by the contact surface 75X of the topper protrusion 75f and the turn of the conductive wire 91 which is at a location denoted by the reference number 21.

The fifth layer turns which form the fifth layer 105 of each of the coils 81, as can be seen in FIG. 7, include the fifth-layer-end portions 5a and 5b located at one of ends of the fifth layer 105 in a transverse section of the coil 81, as cut in the first direction D1. The fifth-layer-end portions 5a and 5b extend in the axial direction A1 on sides of the tooth 65 opposed to each other in the third direction D3. The fifth-layer-end portion 5a is located between the first adjacent wall 72a and the second adjacent wall 73a. The fifth-layer-end portion 5a is defined by one of turns of the conductive wire 91 which is at a location denoted by the reference number 48. The fifth-layer-end portion 5b is located between the first adjacent wall 72a and the second adjacent wall 73a. The fifth-layer-end portion 5b is defined by one of turns of the conductive wire 91 which is at a location denoted by the reference number 49.

The contact surface 75X of the stopper protrusion 75b is placed in direct contact with the fifth-layer-end portion 5a. The fifth-layer-end portion 5a contacts both with the contact surface 75X of the stopper protrusion 75b and with one of the turns of the conductive wire 91 which is at a location denoted by the reference number 34. The fifth-layer-end portion 5a is, like the third-layer-end portion 3a, positioned in the first direction D1 by the contact surface 75X of the topper protrusion 75b and the turn of the conductive wire 91 which is at a location denoted by the reference number 34.

The contact surface 75X of the stopper protrusion 75d is placed in direct contact with the fifth-layer-end portion 5b. The fifth-layer-end portion 5b contacts both with the contact surface 75X of the stopper protrusion 75d and with one of the turns of the conductive wire 91 which is at a location denoted by the reference number 35. The fifth-layer-end portion 5b is, like the third-layer-end portion 3a, positioned in the first direction D1 by the contact surface 75X of the topper protrusion 75d and the turn of the conductive wire 91 which is at a location denoted by the reference number 35.

The contact surface 75X of each of the stopper protrusions 75a to 75f is, as clearly illustrated in FIGS. 7, 10, and 11, a planar surface which has the common line CL3 of tangent both to a fifth peripheral surface and to a sixth peripheral surface, as viewed in the axial direction A1 on a transverse section of the insulator 71. The fifth peripheral surface is an outer surface of the first conductive wire 91A contacting directly with the contact surface 75X when the first conductive wire 91A is wound around the tooth 65 through the insulator 71. The sixth peripheral surface is an outer surface of the second conductive wire 91B contacting directly with the contact surface 75X when the second conductive wire 91B is wound around the tooth 65 through the insulator 71. In other words, each of the contact surfaces 75X is shaped to have a third line of tangent to the outer peripheral surface of the first conductive wire 91A wound around the tooth 65 and also have a fourth line of tangent to the outer peripheral surface of the second conductive wire 91B wound around the tooth 65. Each of the contact surfaces 75X is inclined to the third direction D3 at an angle which is selected to have both the third tangent line and the fourth tangent line.

As viewed in the axial direction A1, the first conductive wire 91A wound around the tooth 65 has the center 01 of a transverse section thereof contacting directly with the contact surface 75X of the stopper protrusion 75a. Similarly, the second conductive wire 91B wound around the tooth 65 has the center O2 of a transverse section thereof contacting directly with the contact surface 75X of the stopper protrusion 75a. The centers O1 and O2 lie on the straight line L11 that is a single line extending perpendicular both to the first direction D1 and to the axial direction A1. Similarly, the center O1 of the transverse section of the first conductive wire 91A contacting directly with the contact surface 75X of each of the stopper protrusions 75b to 75f and the center O2 of the transverse section of the second conductive wire 91B contacting directly with the contact surface 75X of each of the stopper protrusions 75b to 75f are located, as viewed in the axial direction A1, on a single line extending perpendicular both to the first direction D1 and to the axial direction A1. The center of the transverse section of the conductive wire 91 which contacts directly with each of the stopper protrusions 75a to 75d lies on the straight line L11, as viewed in the axial direction A1, regardless of the diameter of the conductive wire 91 as long as it is selected to enable the conductive wire 91 to be held by the retention grooves 74. Similarly, the center of the transverse section of the conductive wire 91 which contacts directly with each of the stopper protrusions 75e and 75f lies on the straight line L12, as viewed in the axial direction A1, regardless of the diameter of the conductive wire 91 as long as it is selected to enable the conductive wire 91 to be held by the retention grooves 74. Consequently, transverse sections of potions of the conductive wire 91 which are aligned with each other in the third direction D3 on sides of the tooth 65 opposed to each other in the third direction D3 have centers which are located at the same position in the first direction D1, that is, aligned with each other in the third direction D3. In other words, such centers lie on a single line extending perpendicular both to the first direction D1 and to the axial direction A1. For instance, turns of the conductive wire 91 which are at locations denoted by the reference numbers 34, 12, 13, and 35 and aligned with each other in the third direction D3 are placed to have transverse sections whose centers lie on the straight line L13, as viewed in the axial direction A1. Similarly, turns of the conductive wire 91 which are at locations denoted by the reference numbers 46, 30, 8, 9, 31, and 47 and aligned with each other in the third direction D3 are placed to have transverse sections whose centers lie on the straight line L14, as viewed in the axial direction A1.

The contact surface 75X of one of the stopper protrusions 75 which is located, as viewed in the axial direction A1, farther away from the tooth 65 in the third direction D3 on each of the first adjacent walls 72a and 72b in FIGS. 7 and 10 may be shaped to have an increased dimension in the third direction D3 which is greater than those of the other protrusions 75. For instance, the stopper protrusion 75b is located farther away from the tooth 65 than the stopper protrusion 75a is in the third direction D3 on the first adjacent wall 72a and, thus, may have the contact surface 75X which has, as illustrated in FIG. 10, the dimension X2 greater than the dimension X1 of the contact surface 75X of the stopper protrusion 75a in the third direction D3.

When the conductive wire 91 whose diameter is large enough to be retained in the retention grooves 74 is wound around each of the teeth 65 through a corresponding one of the insulators 71, it causes the contact surface 75X of each of the stopper protrusions 75 to be arranged in contact with an outer one of the turns of the conductive wire 91 which make a corresponding one of third or subsequent odd-numbered layers. The outer one of the turns is an outermost one of the turns of the conductive wire 91 which face in the first direction D1 or the second direction D2. In other words, when the conductive wire 91 is wound around each of the teeth 65 in the form of multiple layers of turns with the turns of each layer being arranged at a given interval away from each other in the first direction D1 or the second direction D2, the contact surface 75X of each of the stopper protrusions 75 is placed in contact with an outermost one of the turns which make a corresponding one of third or subsequent odd-numbered layers. The contact surface 75X of each of the stopper protrusions 75 is, therefore, designed to have an angle of inclination to the third direction D3, a dimension in the third direction D3, and a location defined in the third direction D3 in order for the contact surface 75X of each of the stopper protrusions 75 to make physical contact with an outermost one of the turns of a corresponding one of third or subsequent odd-numbered layers. The outermost one of the turns is one of the turns of each layer which is located outermost in the first direction D1 or the second direction D2. Consequently, when an end of each of third or subsequent odd-numbered layers of each of the coils 81 contacts the contact surface 75X in the first direction D1 or the second direction D2, the turns of the conductive wire 91 of each layer are arranged at a constant interval away from each other in the first direction D1 or the second direction D2.

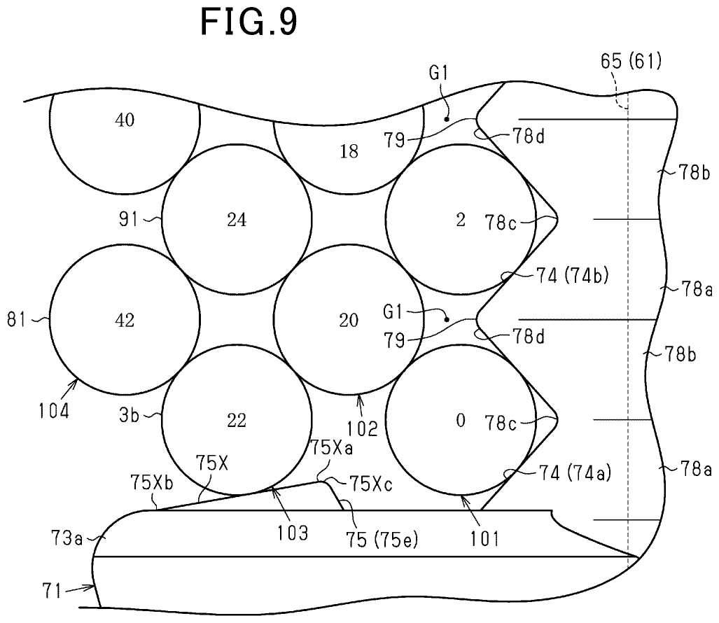

Each of the stopper protrusions 75a to 75f, as illustrated in FIGS. 8 and 9, has the top 75Xc which is farther away from the insulator 71 (i.e., a corresponding one of the first adjacent walls 72a and 72b) in a direction in which the stopper protrusions 75a to 75f bulge (i.e., the first direction D1 or the second direction D2). The top 75Xc may be curved or rounded. Each of the stopper protrusions 75c, 75d, and 75f has the top 75Xc similar to those of the stopper protrusions 75a, 75b, and 75e. For instance, the top 75Xc of each of the stopper protrusions 75a to 75f may be of an arc-shape, as viewed in the axial direction A1, protruding in the direction in which the stopper protrusions 75a to 75f bulge.

### Operation and Beneficial Advantages in the Embodiment

The operation of and beneficial advantages offered by this embodiment will be discussed below.
1) The stator 51 is, as described above, equipped with the stator core 61 which includes the annular member 66 and the teeth 65. The annular member 66 has the first surface 63 extending along the reference axis L1 and is of an annular shape centered at the reference axis L1. The teeth 65 extend from the first surface 63 in a direction perpendicular to the reference axis L1. The stator 51 also includes the insulators 71 and the coils 81. Each of the insulators 71 is fit on a respective one of the teeth 65. Each of the coils 81 is made of the conductive wire 91 wound through one of the insulators 71 around a corresponding one of the teeth 65 in the form of three or more layers of turns. Each of the insulators 71 includes the first adjacent walls 72a and 72b which are located away from the coil 81 in the first direction D1 that is a direction from the top end to the base end of the tooth 65. Each of the first adjacent walls 72a and 72b covers at least a portion of the first surface 63 and is arranged adjacent to the coil 81 in the first direction D1. Each of the insulators 71 also includes the second adjacent walls 73a and 73b which are located away from the coil 81 in the second direction D2 that is a direction from the base end to the top end of the tooth 65. Each of the insulators 71 also has the retention grooves 74 which extend in the tooth 65 in the winding direction C2 and in which turns of the conductive wire 91 which make the first layer of the coil 81 are fit. Each of the insulators 71 also has formed thereon the stopper protrusions 75 which bulge from the first adjacent walls 72a and 72b and/or the second adjacent walls 73a and 73b toward the coil 81. The retention grooves 74 are arranged at equal intervals away from each other in the first direction D1. Each of the retention grooves 74 has the pair of holding surfaces 78a and 78b which are defined by end surfaces thereof facing each other in the first direction D1 and are oriented to slant relative to the first direction D1 to have an interval therebetween which increases from the bottom 78c toward the opening 78d of the retention groove 74. The holding surfaces 78a and 78b of each of the retention grooves 74 contact directly with the outer peripheral surface of one of the turns of the conductive wire 91 fit in a corresponding one of the retention grooves 74. Each of the stopper protrusions 75 has the contact surface 75X which faces in the first direction D1 or the second direction D2 and contacts directly with an outermost one of the turns of a corresponding one of the coils 81 which makes one of third or subsequent odd-numbered layers. The contact surface 75X, as described already, has the first end 75Xa and the second end 75Xb opposed to each other along the reference axis L1, that is, in a direction perpendicular both to the first direction D1 and to the axial direction A1, as viewed in the axial direction A1. The first end 75Xa is located closer to the tooth 65 than the second end 75Xb is. The contact surface 75X is inclined to have the second end 75Xb located farther away from the coil 81 than the first end 75Xa is in the first direction D1.

The holding surfaces 78a and 78b of each of the retention grooves 74 are oriented to slant relative to each other in the first direction D1 to have an interval therebetween in the first direction D1 which increases from the bottom 78c toward the opening 78d. This achieves the stability in positioning the first layer turns of the conductive wire 91 of each of the coils 81 in the first direction D1 within the retention grooves 74 as long as the conductive wire 91 is placed in contact with both the holding surfaces 78a and 78b regardless of the diameter of the conductive wire 91.

The first layer turns of the conductive wire 91 of each of the coils 81 are fit in the retention grooves 74 arranged at equal intervals away from each other in the first direction D1, so that they are wound at constant intervals away from each other around a corresponding one of the teeth 65. The second layer turns of the conductive wire 91 are fit in grooves each of which is formed between outer peripheries of a respective two of the first layer turns which are arranged adjacent to each other in the first direction D1. This causes the second layer turns to be wound at constant intervals away from each other around a corresponding one of the teeth 65. Similarly, the third or subsequent layer turns of the conductive wire 91 are fit in grooves each of which is formed between outer peripheries of a respective adjacent two of the turns last wound around the tooth 65, so that they are positioned at constant intervals away from each other in the first direction D1.

Generally, when the conductive wire 91 is wound in the form of a multiple layers of turns to make the coil 81, a radially outermost surface of a second or subsequent one of the layers will be located farther away from the outer peripheral surface of the tooth 65 with an increase in diameter of the conductive wire 91. Additionally, a distance between each of axially opposed ends of each layer of the turns of the coil 81 and the center of the coil 81 in the first direction D1 will increase with an increase in diameter of the conductive wire 91 unless the number of turns of the conductive wire 91 of each layer is changed. The contact surface 75X of each of the stopper protrusions 75 is, as described already, oriented to slant, as viewed in the axial direction A1, to have the second end 75Xb which is far away from the tooth 65 and located farther away from the coil 81 than the first end 75Xa is in a direction perpendicular both to the first direction D1 and to the axial direction A1. In other words, the contact surface 75X of each of the stopper protrusions 75a to 75f is inclined to have the distance between a portion of the contact surface 75X and the center of the coil 81 in the first direction D1 which increases with an increase in distance of the portion of the contact surface 75X from the tooth 65 in a direction perpendicular to the first direction D1 and the axial direction A1. The above orientation of the contact surface 75X enables the conductive wire 91 to be wound around the tooth 65 to have the same number of turns without having to modify the insulator 71 even when the diameter of the conductive wire 91 is changed. The above orientation of the contact surface 75X of each of the stopper protrusions 75 also ensures the stability in contacting ends of each of third or subsequent odd-numbered layers of the turns which are opposed to each other in the first direction D1 regardless of a change in diameter of the conductive wire 91.

For instance, use of an insulator without the stopper protrusions 75 may result in an air gap appearing between the insulator and an end of one of odd numbered layers of turns of a conductive wire in the first direction D1 depending upon the diameter of the conductive wire. The insulators 71 in this embodiment each include the stopper protrusions 75, thereby minimizing a risk that an air gap may be created between each of the insulators 71 and an end of one of odd numbered layers of turns of the conductive wire 91 in the first direction D1. The contact surface 75X is, as described above, arranged in contact with the end of a corresponding one of third or subsequent odd-numbered layers of turns of the conductive wire 91 in the first direction D1, thereby stopping such an end from moving away from the center of the coil 81 in the first direction D1. In other words, the insulators 71 in this embodiment serves to minimize a risk of deformation of the coils 81 regardless of a change in diameter of the conductive wire 91.

The above structure of each of the insulators 71, therefore, enables the conductive wire 91 to be wound around the tooth 65 to produce the first layer turns which are arranged at constant intervals away from each other in the first direction D1 in spite of a change in diameter of the conductive wire 91. Additionally, the contact surface 75X of each of the stopper protrusions 75 serves to minimize a risk of deformation of more than second odd-numbered layers of the turns of the conductive wire 91 in spite of a change in diameter of the conductive wire 91. This eliminates the need for modifying the design of the insulators 71 even when the diameter of the conductive wire 91 is changed and ensures a required configuration of the coils 81, thereby minimizing a variation in required types of the insulators 71.
2) The contact surface 75X of each of the stopper protrusions 75a to 75f is, as described above, shaped to be planar which has the common line CL3 of tangent both to the third peripheral surface and to the fourth peripheral surface, as viewed in the axial direction A1 on a transverse section of the insulator 71. The third peripheral surface is an outer surface of the first conductive wire 91A contacting directly with the contact surface 75X when the first conductive wire 91A is wound around the tooth 65 through the insulator 71. The fourth peripheral surface is an outer surface of the second conductive wire 91B (which has the second diameter D12 different from that of the first conductive wire 91A) contacting directly with the contact surface 75X when the second conductive wire 91B is wound around the tooth 65 through the insulator 71.

The above structure of the contact surface 75X is, therefore, capable of achieving physical contact with an end of a third or subsequent odd-numbered layer of turns of a corresponding one of the coils 81 in the first direction D1 regardless of whether the conductive wire 91 is made of the first conductive wire 91A or the second conductive wire 91B. For instance, the structure of the contact surface 75X in this embodiment also ensures the stability in achieving physical contact with an end of a third or subsequent odd-numbered layer of turns of a corresponding one of the coils 81 in the first direction D1 in a case where the conductive wire 91 has a diameter intermediate between the first diameter D11 of the first conductive wire 91A and the second diameter D12 of the second conductive wire 91B.
3) The holding surface 78a of each of the retention grooves 74 is, as described above, shaped to contain the common line CL1 of tangent both to the first peripheral surface and to the second peripheral surface, as viewed in a transverse section of the retention groove 74. The first peripheral surface is an outer surface of the first conductive wire 91A contacting directly with the holding surface 78a when the first conductive wire 91A is wound around the tooth 65 through the insulator 71. The second peripheral surface is an outer surface of the second conductive wire 91B contacting directly with the holding surface 78a when the second conductive wire 91B is wound around the tooth 65 through the insulator 71. Similarly, the holding surface 78b of each of the retention grooves 74 is shaped to contain the common line CL2 of tangent both to the third peripheral surface and to the fourth peripheral surface, as viewed in a transverse section of the retention groove 74. The third peripheral surface is an outer surface of the first conductive wire 91A contacting directly with the holding surface 78b when the first conductive wire 91A is wound around the tooth 65 through the insulator 71. The fourth peripheral surface is an outer surface of the second conductive wire 91B contacting directly with the holding surface 78b when the second conductive wire 91B is wound around the tooth 65 through the insulator 71.

The above structure of the retention grooves 74 is capable of positioning the turns of the conductive wire 91 arranged in the retention grooves 74 by means of the holding surfaces 78a and 78b regardless of whether the conductive wire 91 is designed as the first conductive wire 91A or the second conductive wire 91B. Further, the holding surfaces 78a and 78b of the retention grooves 74 in this embodiment also ensure the stability in positioning or holding the turns of the conductive wire 91 arranged in the retention grooves 74 from moving undesirably in the first direction D1 in a case where the conductive wire 91 has a diameter intermediate between the first diameter D11 of the first conductive wire 91A and the second diameter D12 of the second conductive wire 91B.
4) Each of the insulators 71, as described above, has the first adjacent walls 72a and 72b which are respectively arranged on sides of the tooth 65, as viewed in the axial direction A1, opposed to each other in a direction perpendicular both to the first direction D1 and to the axial direction A1. Each of the first adjacent walls 72a and 72b has the stopper protrusions 75 bulging therefrom. The contact surface 75X of one of the stopper protrusions 75 which is located, as viewed in the axial direction A1, farther away from a corresponding one of the teeth 65 in a direction perpendicular to the first direction D1 and the axial direction A1 is shaped to have a dimension which is greater than those of the other protrusions 75 in a direction perpendicular to the first direction D1.

Two types of coils: the first coil 81 and the second coil 81 which are made of conductive wires 91 different in diameter from each other will be discussed. As compared between locations of the same numbered layers of turns of the conductive wires 91 of the first and second coils 81 in a direction perpendicular to the first direction D1 and the axial direction A1, i.e., the third direction D3, an outer one of the layers of the turns of each of the first and second coils 81 will be subjected to a greater error in position in the third direction D3. It is, therefore, easier to arrange an end of an outer one of odd-numbered layers of the turns in alignment with the contact surface 75X in the first direction D1 when the contact surface 75X of one of the stopper protrusions 75 which is farther away from the tooth 65 has a greater dimension in the third direction D3 than those of the other stopper protrusions 75. As compared between locations of the same numbered layers of the turns of the first and second coils 81 in the third direction D3, an inner one of the layers in each of the first and second coils 81 will be subjected to a smaller error in position in the third direction D3 than in the other layers of the turns in either of the first coil 81 or the second coil 81. Consequently, even when the dimension of the contact surface 75X in the third direction D3 is selected to decrease from an outer one of the stopper protrusions 75 which is located away from the tooth 65 to an inner one of the stopper protrusions 75 which is located close to the tooth 65, it is possible to achieve accurate alignment of an end of an inner one of odd numbered layers of the turns in the coil 81 with the contact surface 75X in the first direction D1. The above structure of the stopper protrusions 75, therefore, facilitates physical contact of an end of each of third or subsequent odd-numbered layers with the contact surface 75X of a corresponding one of the stopper protrusions 75 in the first direction D1.
5) The top 75Xc of each of the stopper protrusions 75 which is farthest away from the insulator 71 (i.e., a corresponding one of the first adjacent walls 72a and 72b) is curved or rounded. This shape of the top 75Xc minimizes a risk of damage to the conductive wire 91 which arises from contact of the conductive wire 91 with the top 75Xc when the conductive wire 91 is wound around the tooth 65 through the insulator 71.
6) The retention grooves 74 which are arranged adjacent to each other in the first direction D1 hold therein the first layer turns of the conductive wire 91 so that a respective adjacent two of the first layer turns are disposed with the air gap G1 therebetween.

The above arrangements minimize a risk that a respective two of the first layer turns of the conductive wire 91 which are arranged adjacent to each other in the first direction D1 may contact each other. The second or subsequent layer turns of the conductive wire 91 are arranged at intervals away from each other in the first direction D1 which are identical with those of the first layer turns. In other words, a respective two of the second or subsequent layer turns of the conductive wire 91 are disposed adjacent to each other through an air gap, thereby eliminating the risk of physical contact therebetween, which eliminates mechanical damage to the conductive wire 91.
7) Each of the retention grooves 74 is of a V-shape in a transverse section thereof which is simple or easy to machine. This shape also ensures the stability in positioning the first layer turns of the conductive wire 91 regardless of change in diameter of the conductive wire 91.

### Modifications

The above embodiment may be modified in the following ways. The embodiment and modifications discussed below may be combined in a required manner.

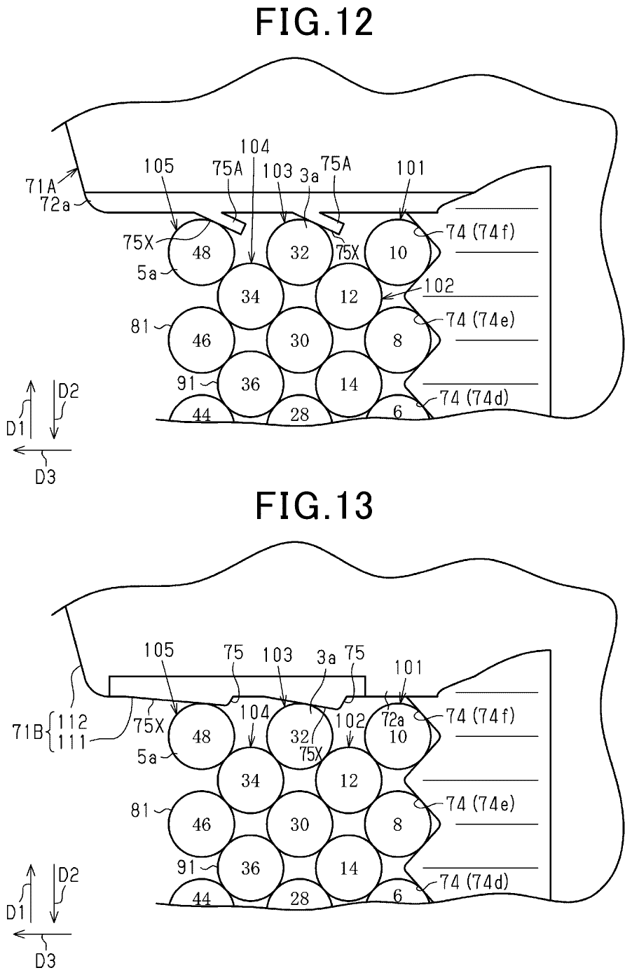

The stator 51 may be, as illustrated in FIG. 12, designed to include the insulators 71A instead of the insulators 71. Each of the insulators 71A has the stopper protrusions 75A instead of the stopper protrusions 75. In FIG. 12, the same reference numbers as employed in the above embodiment refer to the same parts, and explanation thereof in detail will be omitted here. Each of the stopper protrusions 75A is elastically deformable to move the contact surface 75X away from the coil 81 in the first direction D1. Each of the stopper protrusions 75A works to press one of turns of the conductive wire 91 which abuts the contact surface 75X toward the center of the coil 81. For instance, the third-layer-end portion 3a which is at a location denoted by the reference number 32 is mechanically urged by the stopper protrusion 75A in the second direction D2, so that it is pressed against two of turns of the conductive wire 91 which are at locations denoted by the reference numbers 34 and 12.

The above-described structure of the insulators 71A enhances the stability in locations of the odd numbered layers of turns of the conductive wire 91 in the first direction D1, thereby minimizing undesirable deformation of the coils 81. Each of the insulators 71A may be designed to include the stopper protrusion(s) 75 described in the above embodiment and at least one of the stopper protrusions 75A.

The stator 51 may alternatively be designed, as shown in FIG. 13, to include the insulators 71B instead of the insulators 71. Each of the insulators 71B includes the first member 111 and the second member 112 which are discrete from each other. The first member has the stopper protrusions 75 formed thereon and is attached to the second member 112. The first member 111 and the second member 112 may be made from the same kind of material or materials different from each other. The attachment of the first member 111 to the second member 112 may be achieved using a snap-fit feature. Alternatively, the first member 111 may be secured to the second member 112 using pressure-bonding, press-fitting, welding, or pasting techniques.

The above structure of each of the insulators 71B enables the first member 111 to be modified in configuration thereof without need for altering the configuration of the second member 112. For instance, the number, configuration, or attachment locations of the stopper protrusions 75 may be changed without need for modifying the configuration of the second member 112, thereby enabling various types of the conductive wire 91 which are different in diameter thereof to be used. Alternatively, the configuration of the second member 112 may be modified without need for altering the configuration of the first member 111. Different types of the first and second members 111 and 112 may, therefore, be combined to match an increased number of possible modifications of the insulators 71.

The retention grooves 74 which are arranged adjacent to each other in the first direction D1 may be modified to hold the first layer turns of the conductive wire 91 of the coil 81 to be located in abutment with each other without the air gaps G1 therebetween.

The top 75Xc of each of the stopper protrusions 75a to 75f is, as described above, rounded, but however, may alternatively be of another shape. In the above embodiment, one of the stopper protrusions 75 of each of the first adjacent walls 72a and 72b which is located, as viewed in the axial direction A1, farther away from the tooth 65 in the third direction D3, as described already, has an increased dimension of the contact surface 75X in the third direction D3, but however, all the contact surfaces 75X may be shaped to have dimensions identical with each other in the third direction D3. The dimensions of the contact surfaces 75X in the third direction D3 may alternatively be selected to be different from each other as needed.

The number of the stopper protrusions 75 each of the insulators 71 has may be changed as needed. Each of the insulators 71 may be designed to have at least one stopper protrusion 75 bulging from at least one of the first adjacent walls 72a and 72b and the second adjacent walls 73a and 73b. This arrangement is also capable of minimizing a risk that the coil 81 may be deformed around an end of odd numbered layers of turns of the coil 81 in the first direction D1.

The retention grooves 74 may be formed only in the side surface covers 76b and 76c or alternatively only in the end surface cover 76a. The configuration of each of the insulators 71 may be of a shape different from that discussed above as long as each of the insulators 71 includes the first adjacent walls 72a and 72b, the second adjacent walls 73a and 73b, the retention grooves 74, and the stopper protrusions 75. For instance, each of the insulators 71 may be configured to have the first provisional retention groove 73c and the second provisional retention groove 73d formed in the yoke-end-surface cover 77. In this structure, the first provisional retention groove 73c and the second provisional retention groove 73d are formed to extend through the yoke-end-surface cover 77 in the first direction D1 and have openings facing in the axial direction A1.

The shape or structure of the stator core 61 may be modified as needed. For instance, the number of the core segments of the stator core 61 is, as described above, twelve, but may be another number more than one. The stator core 61 may not be made of a plurality of segments arranged adjacent to each other in the circumferential direction C1. The stator core 61 may also be designed to include the annular member 66 and the teeth 65 extending outside the annular member 66.

Technical aspects of the above-described embodiment and modifications will be described below.
a) The stator as set forth in claim 1 or 2, wherein the conductive wire includes a first conductive wire (91A) and a second conductive wire (91B) different in diameter from the first conductive wire. The holding surfaces of each of the retention grooves are surfaces each of which is shaped to contain a common line (CL1, CL2) of tangent both to a third peripheral surface and to a fourth peripheral surface, as viewed in a transverse section of a corresponding one of the retention grooves. The third peripheral surface is an outer surface of the first conductive wire contacting with one of the holding surfaces when the first conductive wire is wound around a corresponding one of the teeth through a corresponding one of the insulators. The fourth peripheral surface is an outer surface of the second conductive wire contacting with one of the holding surfaces when the second conductive wire is wound around a corresponding one of the teeth through a corresponding one of the insulators.
b) The stator as set forth in claim 1, 2, or a), wherein each of the insulators includes the first adjacent walls which are arranged, as viewed along the reference axis, on sides of a corresponding one of the teeth which are opposed to each other in a direction perpendicular to the first direction. Each of the first adjacent walls has the plurality of stopper protrusions provided thereon. The contact surface of one of the stopper protrusions which is located, as viewed along the reference axis, farther away from a corresponding one of the teeth in a direction perpendicular to the first direction is shaped to have a dimension which is greater than those of the other protrusions in the direction perpendicular to the first direction.
c) The stator as set forth in claim 1, 2, a), or b), wherein each of the stopper protrusions has a top (75Xc) which is farther away from a corresponding one of the insulators in a direction in which the stopper protrusions protrude. The top is rounded in shape.
d) The stator as set forth in claim 1, 2, or one of a) to c), wherein the retention grooves which are arranged adjacent to each other in the first direction hold therein the first layer turns of the conductive wire to arrange a respective two of the first layer turns which are adjacent to each other through an air gap (G1) in the first direction.
e) The stator as set forth in claim 1, 2, or one of a) to d), wherein each of the retention grooves is of a V-shape in a transverse section thereof.
f) The stator as set forth in claim 1, 2, or one of a) to e), wherein at least one of the stopper protrusions is elastically deformable to move a corresponding one of the contact surfaces away from a corresponding one of the coils in the first direction and works to press one of the turns of the conductive wire which abuts a corresponding one of the contact surfaces toward the center of a corresponding one of the coils.
g) The stator as set forth in claim 1, 2, or one of a) to f), wherein each of the insulators includes a first member (111) and a second member (112) which are discrete from each other, the first member being equipped with the stopper protrusions and secured to the second member.

The above-described elements are only examples. It is apparent for one of ordinary skill in the art that it is possible to combine or modify structural elements or production methods discussed above in order to facilitate understanding of technology in this disclosure or to use alternatives thereof.

This disclosure is not limited to the above embodiments, but may be realized by various embodiments without departing from the purpose of the disclosure. This disclosure includes all possible combinations of the features of the above embodiments or features similar to the parts of the above embodiments. The structures in this disclosure may include only one or some of the features discussed in the above embodiments unless otherwise inconsistent with the aspects of this disclosure.

1. A stator comprising:
a stator core which includes an annular member and teeth, the annular member having a first surface extending in a reference axis, the annular member being centered at the reference axis, the teeth extending from the first surface in a direction perpendicular to the reference axis, each of the teeth having a top end defining a radially inner end and a base end defining a radially outer end;
a plurality of insulators each of which is fit on a respective one of the teeth; and
a plurality of coils each of which is made of a conductive wire wound around a respective one of the teeth through a respective one of the insulators in a form of three or more layers of turns, wherein
each of the insulators includes first adjacent walls, second adjacent walls, a plurality of retention grooves, and a plurality of stopper protrusions, the first adjacent walls being arranged away from a corresponding one of the coils in a first direction oriented from the top end to the base end of a corresponding one of the teeth, the first adjacent walls covering at least a portion of the first surface and being located adjacent to a corresponding one of the coils in the first direction, the second adjacent walls being arranged away from a corresponding one of the coils in a second direction oriented from the base end to the top end of a corresponding one of the teeth and located adjacent to a corresponding one of the coils in the second direction, each of the retention grooves extending in a winding direction in which a corresponding one of the coils is wound around a corresponding one of the teeth, the retention grooves having disposed therein first layer turns that are the turns of the conductive wire making a first one of the layers, the stopper protrusions protruding from at least one of the first adjacent walls and the second adjacent walls toward a corresponding one of the coils,
the retention grooves are arranged at equal intervals away from each other,
each of the retention grooves having a pair of holding surfaces which face each other in the first direction, the holding surfaces being oriented to slant in the first direction to have an interval therebetween in the first direction which increases from a bottom toward an opening of a corresponding one of the retention grooves,
the holding surfaces of each of the retention grooves are placed in contact with an outer peripheral surface of a corresponding one of the turns which is disposed in a corresponding one of the retention grooves,
each of the stopper protrusions has a contact surface which contacts an end of a third or subsequent odd-numbered layer of the turns of a corresponding one of the coils in the first direction,
the contact surface of each of the stopper protrusions has a first end and a second end which opposed to each other in a direction perpendicular to the first direction, as viewed along the reference axis, the first end being located closer to a corresponding one of the teeth than the second end is, the contact surface being inclined to have the second end located farther away from a corresponding one of the coils than the first end is in the first direction.

2. The stator as set forth in claim 1, wherein the conductive wire includes a first conductive wire and a second conductive wire different in diameter from the first conductive wire, and
the contact surface of each of the stopper protrusions is a planar surface which is oriented to have a common line of tangent both to a first peripheral surface and to a second peripheral surface, as viewed along the reference axis, the first peripheral surface being an outer surface of the first conductive wire contacting with the contact surface when the first conductive wire is wound around a corresponding one of the teeth through a corresponding one of the insulators, the second peripheral surface being an outer surface of the second conductive wire contacting with the contact surface when the second conductive wire is wound around a corresponding one of the teeth through a corresponding one of the insulators.

3. The stator as set forth in claim 1, wherein the conductive wire includes a first conductive wire and a second conductive wire different in diameter from the first conductive wire, and
the holding surfaces of each of the retention grooves are surfaces each of which is shaped to contain a common line of tangent both to a third peripheral surface and to a fourth peripheral surface, as viewed in a transverse section of a corresponding one of the retention grooves, the third peripheral surface being an outer surface of the first conductive wire contacting with one of the holding surfaces when the first conductive wire is wound around a corresponding one of the teeth through a corresponding one of the insulators, the fourth peripheral surface being an outer surface of the second conductive wire contacting with one of the holding surfaces when the second conductive wire is wound around a corresponding one of the teeth through a corresponding one of the insulators.

4. The stator as set forth in claim 1, wherein each of the insulators includes the first adjacent walls which are arranged, as viewed along the reference axis, on sides of a corresponding one of the teeth which are opposed to each other in a direction perpendicular to the first direction,
each of the first adjacent walls has the plurality of stopper protrusions provided thereon, and
the contact surface of one of the stopper protrusions which is located, as viewed along the reference axis, farther away from a corresponding one of the teeth in a direction perpendicular to the first direction is shaped to have a dimension which is greater than those of the other protrusions in the direction perpendicular to the first direction.

5. The stator as set forth in claim 1, wherein each of the stopper protrusions has a top which is farther away from a corresponding one of the insulators in a direction in which the stopper protrusions protrude, the top being rounded in shape.

6. The stator as set forth in claim 1, wherein the retention grooves which are arranged adjacent to each other in the first direction hold therein the first layer turns of the conductive wire to arrange a respective two of the first layer turns which are adjacent to each other through an air gap in the first direction.

7. The stator as set forth in claim 1, wherein each of the retention grooves is of a V-shape in a transverse section thereof.

8. The stator as set forth in claim 1, wherein at least one of the stopper protrusions is elastically deformable to move a corresponding one of the contact surfaces away from a corresponding one of the coils in the first direction and works to press one of the turns of the conductive wire which abuts a corresponding one of the contact surfaces toward the center of a corresponding one of the coils.

9. The stator as set forth in claim 1, wherein each of the insulators includes a first member and a second member which are discrete from each other, the first member being equipped with the stopper protrusions and secured to the second member.
